(19) United States
(12) Patent Application Publication
(10) Pub. No.: US 2025/0329049 A1
(43) Pub. Date: Oct. 23, 2025

(54) SYSTEMS AND METHODS OF CONVERGENCE OF BASKET SPOKES FOR A DETERMINATION OF A LOCATION OF AN AERIAL REFUELING DRAGUE

(71) Applicant: THE BOEING COMPANY, Arlington, VA (US)

(72) Inventors: Ryan P. McClintock, Brentwood, MO (US); Caleb G. Price, Brentwood, MO (US); Christian Louis Carini, St. Louis, MO (US)

(21) Appl. No.: 18/802,968

(22) Filed: Aug. 13, 2024

Related U.S. Application Data
(60) Provisional application No. 63/637,699, filed on Apr. 23, 2024.

(51) Int. Cl. G06T 7/73; G06T 7/13

(52) U.S. Cl. CPC G06T 7/74; G06T 7/13; G06T 2207/10048; G06T 2207/30252

(57) ABSTRACT

This disclosure provides systems, methods, and devices for performing thermal image-based identification, such as identification of a location of an object. In some aspects, a device includes a vision processor. The vision processor is configured to obtain, based on thermal image data representing an image that depicts at least a portion of an object, a location associated with a point-of-convergence. The point-of-convergence associated with the multiple structures of the object. The vision processor is also configured to identify the object based on the location.

### CROSS-REFERENCE TO RELATED APPLICATIONS

The present application claims the benefit of U.S. Provisional Patent Application No. 63/637,699 entitled “SYSTEMS AND METHODS OF CONVERGENCE OF BASKET SPOKES FOR A DETERMINATION OF A LOCATION OF AN AERIAL REFUELING DROGUE,” filed Apr. 23, 2024, the contents of which are incorporated by reference in their entirety.

### FIELD OF THE DISCLOSURE

The present disclosure is generally related to identification of a location of an object, such as a drogue.

### BACKGROUND

Highly skilled human operators are typically used to guide complex, high-speed docking operations, such as air-to-air refueling and spacecraft docking operations. As such, the operations rely heavily on human judgment, which is sometimes supplemented by computer vision techniques. To illustrate, complex stereoscopic vision systems may be used to aid the human operator in mating connectors (e.g., a receiver and refueling boom or docking connectors). These docking operations can be complex and involve precision maneuvers, making such operations difficult to extend to autonomous vehicles such as drones, drone aircraft, or autonomous spacecraft. Additionally, artificial intelligence-based solutions can be challenging to test, resulting in difficulty certifying such systems with industry organizations or governments.

### SUMMARY

In an aspect, a device includes a vision processor. The vision processor is configured to obtain, based on thermal image data representing an image that depicts at least a portion of an object, a gradient of at least a portion of the image. The portion of the image includes multiple pixels associated with multiple structures of the object. The vision processor is also configured to, for each pixel of the multiple pixels of the portion of the image, project, based on the gradient, a vector from the pixel. The vision processor is further configured to populate an accumulator map based on the projected vectors, and determine an estimate of a center of the object based on the accumulator map.

In another aspect, a method includes obtaining, based on thermal image data representing an image that depicts at least a portion of an object, a gradient of at least a portion of the image. The portion of the image includes multiple pixels associated with multiple structures of the object. The method also includes, for each pixel of the multiple pixels of the portion of the image, projecting, based on the gradient, a vector from the pixel. The method includes populating an accumulator map based on the projected vectors. The method further includes determining an estimate of a center of the object based on the accumulator map.

In another aspect, a non-transitory, computer-readable medium stores instructions that, when executed by one or more processors, cause the one or more processors to perform operations including obtaining, based on thermal image data representing an image that depicts at least a portion of an object, a gradient of at least a portion of the image. The portion of the image includes multiple pixels associated with multiple structures of the object. The operations also include, for each pixel of the multiple pixels of the portion of the image, projecting, based on the gradient, a vector from the pixel. The operations include populating an accumulator map based on the projected vectors. The operations further include determining an estimate of a center of the object based on the accumulator map.

In another aspect, a device includes a vision processor. The vision processor is configured to obtain, based on thermal image data of an image depicting at least a portion of an object, a location associated with a point-of-convergence of multiple structures of the object. The vision processor is also configured to identify the object based on the location.

In another aspect, a method includes obtaining, based on thermal image data of an image depicting at least a portion of an object, a location associated with a point-of-convergence of multiple structures of the object. The method also includes identifying the object based on the location.

In another aspect, a non-transitory, computer-readable medium stores instructions that, when executed by one or more processors, cause the one or more processors to perform operations including obtaining, based on thermal image data of an image depicting at least a portion of an object, a location associated with a point-of-convergence of multiple structures of the object. The operations also include identifying the object based on the location.

The features, functions, and advantages described herein can be achieved independently in various implementations or may be combined in yet other implementations, further details of which can be found with reference to the following description and drawings.

### BRIEF DESCRIPTION OF THE DRAWINGS

FIGS. 1A-1E illustrate examples of a system configured to identify a location of a drogue according to one or more aspects of the present disclosure.

FIG. 2 is a diagram that illustrates an example of a system configured to identify a location of a drogue according to one or more aspects of the present disclosure.

FIG. 3 depicts an example of a technique to generate an accumulator map according to one or more aspects of the present disclosure.

FIG. 4 depicts an example of another technique to generate an accumulator map according to one or more aspects of the present disclosure.

FIG. 5 depicts an example of a technique to identify a location of a drogue according to one or more aspects of the present disclosure.

FIG. 6 depicts an example of another technique to identify a location of a drogue according to one or more aspects of the present disclosure.

FIG. 7 depicts examples of other techniques to identify a location of a drogue according to one or more aspects of the present disclosure.

FIG. 8 is a diagram that illustrates a flow chart of an example of a method of identifying a location of an object according to one or more aspects of the present disclosure.

FIG. 9 is a flowchart illustrating an example of a life cycle of an aircraft including a vision system configured to identify a location of an object according to one or more aspects of the present disclosure.

FIG. 10 is a block diagram of a particular implementation of the aircraft associated with the life cycle of FIG. 9 according to one or more aspects of the present disclosure.

FIG. 11 is a block diagram of a computing environment including a computing device configured to support aspects of computer-implemented methods and computer-executable program instructions (or code) according to one or more aspects of the present disclosure.

### DETAILED DESCRIPTION

Aspects disclosed herein present systems and methods of thermal image-based detection of a location or an estimated location of a connector of a vehicle to be mated with a connector of an autonomous or semi-autonomous vehicle. For example, a vision processor that resides onboard a first aircraft, such as a drone aircraft, another type of autonomous aircraft or semi-autonomous aircraft (e.g., an aircraft that implements an autonomous aerial refueling receive (A2R2) capability), or an autonomous or semi-autonomous spacecraft, can process thermal image data from a thermal imaging sensor, such as an infrared camera, to detector or identify a second connector of a second aircraft depicted in the thermal image data. The second aircraft may include an aircraft, another autonomous or semi-autonomous aircraft, or an autonomous or semi-autonomous spacecraft, such as a refueling tanker, that includes the second connector with which a first connector of the first aircraft is configured to mate. In implementations described herein, the first connector includes a probe, a fuel receptacle, a docking appendage, or the like, and the second connector includes an object, such as a drogue basket (e.g., a drogue or a basket), a refueling boom, a docking clamp or receptacle, a socket, or the like. In some implementations, the vision processor outputs an indication of a location or an estimated location of the second connector (or a portion thereof) to one or more other processor(s), such as a guidance processor of a navigation system, to enable the guidance processor to determine and initiate the performance of maneuvers to guide the first aircraft to mate the first connector (e.g., the probe) to the second connector (e.g., the drogue basket). As an example, the location and/or the estimated location output by the vision processor can enable the guidance processor to maneuver the first aircraft such that a refueling connector (e.g., the probe) is mated to a refueling port (e.g., the drogue) of the second aircraft during air-to-air refueling operations. As another example, the location or the estimated location output by the vision processor can enable the guidance processor to maneuver the first aircraft such that one spacecraft is docked to another spacecraft (e.g., via mating the first and second connectors). In implementations, the vision processor is used to support the guidance processor instead of using a human operator to reduce costs, such as costs associated with training human operators and costs associated with operations to mate connectors.

In some contexts, the two aircraft performing mating (e.g., of connectors) include a primary aircraft and a secondary aircraft. Although the terms may be arbitrarily assigned in some contexts (such as where two peer aircraft are mating), generally, the primary aircraft refers to an aircraft that is connecting to the secondary aircraft to be serviced by the secondary aircraft, or the primary aircraft refers to the aircraft, onboard which the vision processor resides. To illustrate, in an air-to-air refueling context, the primary aircraft is the receiving aircraft (e.g., the aircraft to be refueled). Likewise, the secondary aircraft refers to the other aircraft of a pair of aircraft. To illustrate, in the air-to-air refueling context, the secondary aircraft is the tanker aircraft. Although predominately referred to herein as aircraft, the first aircraft and the second aircraft can also be referred to as a first device and a second device, with the term device used broadly to include an object, system, or assembly of components that is/are operated upon as a unit (e.g., in the case of the secondary device) or that operate cooperatively to achieve a task (e.g., in the case of the primary device).

In a particular aspect, the first aircraft uses a vision processor to obtain, based on thermal image data of an image associated with the second connector (e.g., a drogue), a location associated with a point-of-convergence of multiple structures of the second connector, such as one or more spokes of the drogue. To illustrate, the first aircraft can use a thermal imaging device (e.g., a long-wave infrared (LWIR) camera) to capture the thermal image data of at least a portion of a second connector of the second aircraft. In some implementations, the vision processor can receive the thermal image data from the thermal imaging device and obtain, based on the thermal image data, a gradient of at least a portion of the image. In some examples, the portion of the image includes multiple pixels associated with multiple structures of the second connector (e.g., the drogue) and the gradient includes a magnitude (e.g., an edge strength value), a direction (e.g., an orientation, an edge direction vector, or an edge normal vector), or a combination thereof, for each of one or more of the multiple pixels.

To identify the point of convergence, the vision processor projects, for each pixel of the multiple pixels of the portion of the image and based on the gradient, a vector from the pixel. The vector may have a length that is based on a dimension (e.g., a radius) of the drogue. As an example, for a pixel, the vision processor projects a vector (e.g., an edge direction vector) that is normal to the direction of the gradient (e.g., an edge extension) for the pixel. In some implementations, the vision processor can project two normal vectors with respect to the direction of the gradient, such as a first vector that extends at a 90 degree angle with respect to the direction of the gradient and a second vector that extends at a −90 degree angle with respect to the direction of the gradient. Projecting two vectors can account for either a positive or negative contrast edge of the gradient. In some implementations, prior to projecting the vector(s), the vision processor performs a thresholding operation to filter the gradient to remove pixels (e.g., points) that have a weak gradient magnitude (e.g., pixels having gradient magnitudes that fail to satisfy a threshold), are adjacent to points/pixels with a gradient with a higher local maximum (e.g., a gradient magnitude value), or a combination thereof. It is noted that the gradient magnitude of the gradient at a pixel may also be referred to herein as an edge strength or gradient strength at the pixel. By performing the thresholding operation prior to the projecting the vector(s), the vision processor projects the vector(s) only for pixels that satisfy the thresholding for the gradient, which can reduce the computational complexity of identifying the point of convergence.

Based on the projection of the vectors from the multiple pixels of the portion of the image, the vision processor populates an accumulator map and determines an estimated location of the second connector based on the accumulator map. For example, for each vector, the vision processor can increment the value of one or more cells of the accumulator map based on a portion, an end, or an entirety of the vector. To illustrate, a value of a cell of the accumulator map can be populated to reflect a number of vectors that are included in, overlap, or touch the cell. A cell having a peak value of the accumulator map can indicate an estimate of a location (e.g., a center) of the drogue. To illustrate, the estimated location can correspond to a peak (e.g., a cell having a largest value) of the accumulator map which indicates a probable convergence point associated with the second connector (e.g., a convergence point of the spokes or other structures of the second connector). It is noted that a resolution (e.g., a number of cells) of the accumulator map can be the same or lower as a resolution (e.g., a number of pixels) of the image or the portion of the image.

After determining the estimated location, the vision processor uses the estimated location to determine a location of the second connector, to identify and/or track the second connector, or a combination thereof. For example, the vision processor can score the accumulator map based on identification and characterization of discrete blobs to identify an estimated location of the second connector. Additionally, the vision processor can generate additional data associated with the characterization of the discrete blobs. In some implementations, the vision processor can identify multiple estimated locations of the second connector, and score each of the multiple estimated locations. The vison processor can then select one of the estimated locations based on the scores for identification/tracking of the second connector or pass this information to a guidance processer which makes the determination, and either the vision processor or the guidance processor can enable the first aircraft to perform an aerial refueling operation with the second aircraft.

One benefit of the disclosed systems and methods is that the vision processor and the thermal imaging sensor provide an all-optical, passive solution for detection of the second connector and mating, during flight, of the first connector of an autonomous or semi-autonomous vehicle with the second connector. For example, by leveraging a physical structure of the second connector (e.g., spokes of a drogue), the vision processor described in aspects herein can process thermal images and determine gradients to detect the second connector or a portion thereof, such as a socket of the second connector to be connected to the first connector. It is noted that the socket of the second connector may be at a different location from a circular-symmetric apparent center of a front of a skirt of the second connector. In some implementations, the vision processor is configured to detect a location of the second connector, such as a center of a socket (e.g., a center of an opening of the socket configured to receive the first connector). Additionally, the systems and methods disclosed herein can provide autonomous mating of connectors between aircraft without significantly increasing cost or complexity of the systems onboard the autonomous aircraft. To illustrate, highly reliable detection can be provided without significantly increasing the cost or complexity of the first aircraft, as the thermal imaging sensor and the vision processor represent a relatively small and low-cost portion of the overall processing resources and sensors onboard the first aircraft. Additionally, or alternatively, the vision processor can provide a real-time location or estimated location of the second connector. Further, using vision-based maneuvering to control autonomous aircraft or spacecraft during complicated maneuvers, such as aerial refueling or docking, can reduce costs and resources as compared to training human operators to control the aircraft, as well as providing more predictable and repeatable maneuvers than using human operators.

The figures and the following description illustrate specific exemplary embodiments. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific embodiments or examples described below, but by the claims and their equivalents.

Particular implementations are described herein with reference to the drawings. In the description, common features are designated by common reference numbers throughout the drawings. In some drawings, multiple instances of a particular type of feature are used. Although these features are physically and/or logically distinct, the same reference number is used for each, and the different instances are distinguished by addition of a letter to the reference number. When the features as a group or a type are referred to herein (e.g., when no particular one of the features is being referenced), the reference number is used without a distinguishing letter. However, when one particular feature of multiple features of the same type is referred to herein, the reference number is used with the distinguishing letter.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, a system may be described herein as including one or more computing devices (“computing device(s)”), which indicates that in some implementations the system includes a single computing device and in other implementations the system includes multiple computing devices. For ease of reference herein, such features are generally introduced as “one or more” features, and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent; and the term “approximately” may be substituted with “within 10 percent of” what is specified. The statement “substantially X to Y” has the same meaning as “substantially X to substantially Y,” unless indicated otherwise. Likewise, the statement “substantially X, Y, or substantially Z” has the same meaning as “substantially X, substantially Y, or substantially Z,” unless indicated otherwise.

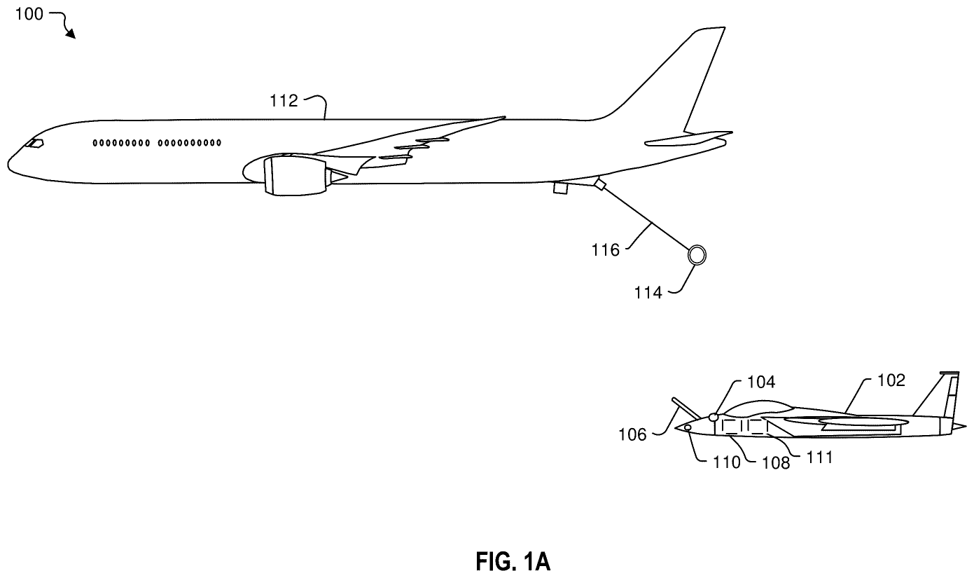

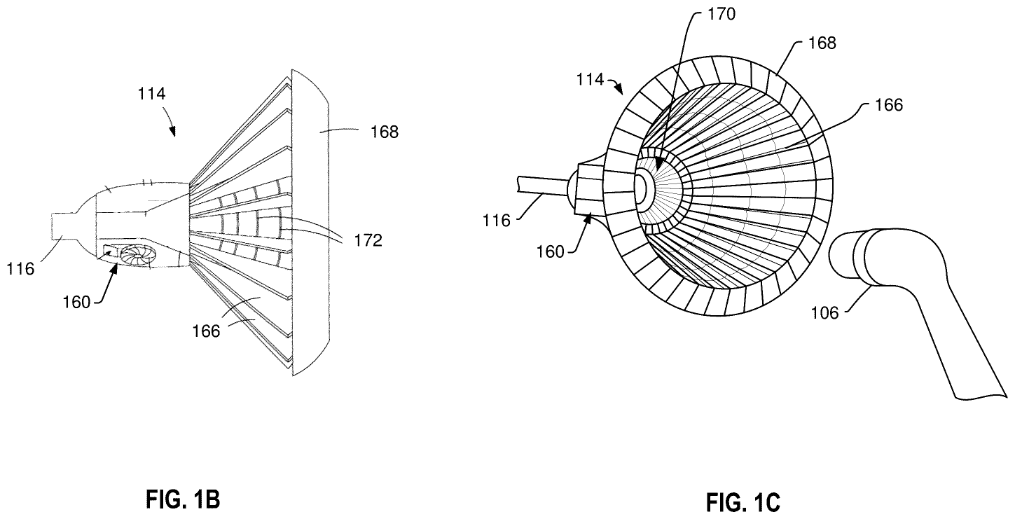

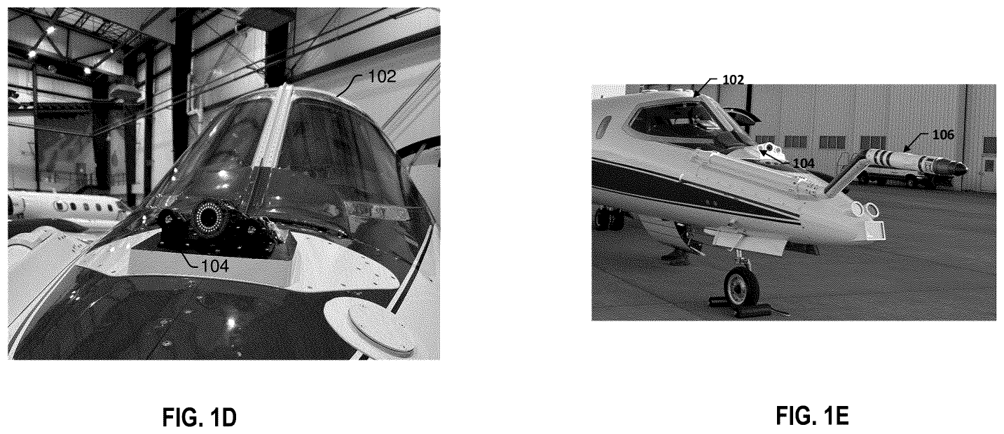

FIGS. 1A-1E illustrate examples of a system 100 for identifying a location of a drogue according to one or more aspects of the present disclosure. Although described with reference to identifying a location of a drogue, one or more techniques described herein with respect to identifying a location of a drogue may be used to identify a location of an object.

FIG. 1A is a diagram that illustrates the system 100 including several aircraft including a first aircraft 102 and a second aircraft 112. FIG. 1B is a diagram of a side-view of an example of a drogue 114 of the second aircraft 112. FIG. 1C is a diagram of an example of the drogue 114 and a probe 106 of the first aircraft 102. FIGS. 1D and 1E are each an image of an example of a first aircraft 102.

Referring to FIG. 1A, the system 100 includes the first aircraft 102 and the second aircraft 112. The first aircraft 102 is configured to identify or estimate a location of a drogue 114 (e.g., a basket) of the second aircraft 112. For example, the first aircraft 102 can detect or estimate a location of the drogue 114 based on thermal image data. Detection or estimation of the location of the drogue 114 can enable the first aircraft 102 to identify or track the drogue 114. In some implementations, detection of the location of the drogue 114 can enable the first aircraft 102 to perform one or more maneuvers to mate the probe 106 (also referred to as a first connector) of the first aircraft 102 with the drogue 114, also referred to as a second connector, of the second aircraft 112.

In the example illustrated in FIG. 1A, the first aircraft 102 includes or corresponds to an autonomous aircraft, such as a drone or drone aircraft, a semi-autonomous aircraft (e.g., an aircraft that supports an A2R2 capability), an autonomous or semi-autonomous spacecraft, or the like (a primary device, as described above), and the second aircraft 112 includes or corresponds to a fuel tanker (a secondary device, as described above). For example, the second aircraft 112 can be configured to service or support the first aircraft 102, such as providing fuel or a refueling service, and the first aircraft 102 includes a device or system configured to couple to the second aircraft 112 and possibly to be serviced by or supported by the second aircraft 112. Although described in the context of a fuel tanker and an autonomous or semi-autonomous aircraft, in other implementations, the first aircraft 102 can include other types of aircraft or spacecraft, such as a space shuttle, and the second aircraft 112 can include other types of aircraft of spacecraft, such as a space station with which the first aircraft 102 is configured to dock.

The second aircraft 112 is coupled via a hose 116 to the drogue 114. The first aircraft 102 includes the probe 106 that is configured to couple with (e.g., physically attach to) the drogue 114. The second aircraft 112 is configured to provide fuel via the hose 116 to the first aircraft 102 while the probe 106 is coupled to the drogue 114. Although the drogue 114 is illustrated in FIG. 1A as being coupled to the second aircraft 112 via the hose 116, in some other implementations, the second aircraft 112 includes a moveable coupling system configured to move the drogue 114 (or another type of connector) relative to the probe 106 (or another type of connector) of the first aircraft 102. For example, the moveable coupling system of the second aircraft 112 can include a steerable boom (e.g., a refueling boom) of a refueling system or a steerable docking arm of a docking system. The above referenced examples are merely illustrative and are not limiting. Additionally, the second aircraft 112 includes a fuel tank to supply fuel, via the hose 116 (or a refueling boom), to the first aircraft 102.

Referring to FIGS. 1B and 1C, the drogue 114 includes a reception coupling 160 and an array of structures 166 (also referred to herein as arms or spokes) extending therefrom and which support a canopy 168 at the distal ends thereof. The reception coupling 160 includes an internal passage 170 (e.g., a socket) for receiving a refueling probe (e.g., the probe 106) and is attached to a fuel hose (e.g., the hose 116). The structures 166 surround the entrance to the internal passage 170 and may each be joined to adjacent arms by couplings 172 (e.g., tie ropes, wires, or other material) for avoiding penetration between the structures 166 by the probe 106. The structures 166 may each have a planar (or substantially planar) body portion, extending radially from an opening/center of the internal passage 170 (e.g., socket) the drogue 114.

Referring to FIGS. 1A, 1D, and 1E, the first aircraft 102 includes a thermal imaging sensor 104. In an example, the thermal imaging sensor 104 includes a long-wave infrared (LWIR) camera or another type of infrared (IR) camera. The thermal imaging sensor 104 is configured to generate thermal image data (e.g., thermal image(s)) that depicts temperature information associated with at least a portion of the second aircraft 112. For example, the LWIR camera can be configured to generate thermal image data based on wavelengths ranging from 8 μm to 14 μm. In some implementations, the thermal image data represents a stream of real-time (e.g., subject to only minor video front-end processing delays and buffering) thermal image frames that represent relative temperatures and relative positions of at least a portion of the drogue 114, at least a portion of the second aircraft 112, or a combination thereof. In a particular aspect, the thermal imaging sensor 104 is located within a housing that is coupled to a hull of the first aircraft 102 and that includes an aperture that provides a field of view for thermal imaging sensor 104. Alternatively, the thermal imaging sensor 104 can be located at or near an end of the probe 106. In some implementations, the first aircraft 102 includes multiple thermal imaging sensors 104 positioned at one or more locations with respect to the hull, the probe 106, or a combination thereof.

Referring to FIG. 1A, the first aircraft 102 also includes a vision processor 108, an optional memory (not shown in FIGS. 1A-1E), one or more additional processors 111, and optionally, one or more sensors 110. In the example illustrated in FIGS. 1A-1E, the vision processor 108 includes or corresponds to one or more image processors. In examples, the additional processor(s) 111 include or correspond to one or more guidance processors, one or more navigational processors, one or more processors of a flight control system, other types of processors, or a combination thereof. In some implementations, the vision processor 108 and the additional processor(s) 111 are combined. To illustrate, one or more graphics processing units (GPUs), one or more central processing units (CPUs), one or more field programmable gate arrays (FPGAs), one or more digital signal processors (DSPs), or one or more other multi-core or multi-thread processing units may serve as both the vision processor 108 and the additional processor(s) 111. Although some implementations include the memory, in other implementations, the memory is omitted from the first aircraft 102.

The sensor(s) 110, when present, are configured to generate supplemental sensor data (e.g., additional image and/or position data) indicative of relative positions of the first aircraft 102 and the second aircraft 112. For example, the sensor(s) 110 may include a camera, a video capture device, a light emitting diode (LED) device, position sensors (e.g., gyroscope(s), accelerometer(s), inertial navigation system (INS) sensors, and the like), and sensor data generated by the sensor(s) 110 can include additional image data, video data, position data, such as 6 degrees of freedom (6 DoF) position data, INS data, or a combination thereof. Additionally, or alternatively, the sensor(s) 110 may include a range finder (e.g., a laser range finder and/or a radio with ranging capability, such as a tactical radio), and the sensor data generated by the sensor(s) 110 can include range data (e.g., a distance from the range finder to the second aircraft 112). Additionally, or alternatively, the sensor(s) 110 may include a radar system, and the sensor data generated by the sensor(s) 110 may include radar data (e.g., radar returns indicating a distance to the second aircraft 112, a direction to the second aircraft 112, or both). Additionally, or alternatively, the sensor(s) 110 may include a light detection and ranging (lidar) system, and the sensor data generated by the sensor(s) 110 may include lidar data (e.g., lidar returns data indicating a distance to the second aircraft 112, a direction to the second aircraft 112, or both). Additionally, or alternatively, the sensor(s) 110 may include a sonar system, and the sensor data generated by the sensor(s) 110 may include sonar data (e.g., sonar returns indicating a distance to the second aircraft 112, a direction to the second aircraft 112, or both). Additionally, or alternatively, the sensor(s) 110 may include one or more additional cameras (e.g., in addition to the thermal imaging sensor 104), and the sensor data generated by the sensor(s) 110 may include stereoscopic image data.

During operation, the first aircraft 102 can activate the thermal imaging sensor 104 to capture thermal image data representing at least a portion of the second aircraft 112, at least a portion of the drogue 114, or a combination thereof. In implementations that include the sensor(s) 110, the sensor(s) 110 can capture additional sensor data associated with the second aircraft 112, the drogue 114, or both. The vision processor 108 processes the thermal image data to detect a location (e.g., an estimated location) of the drogue 114, or a portion thereof. The vision processor 108 provides information associated with the location or the estimated location of the drogue 114 to the additional processor(s) 111. In some implementations, the vision processor 108 processes the additional sensor data to detect a location (e.g., an estimated location) of the drogue 114, or a portion thereof, using other techniques and the additional sensor data, and the vision processor 108 provides information associated with the location or the estimated location detected based on the additional sensor data to the additional processor(s) 111. In this example, the vision processor 108 can provide scores (e.g., confidence scores) associated with the location, estimated location, or a combination thereof, to the additional processor(s) 111. The additional processor(s) 111 can determine navigation for the first aircraft 102 and/or maneuver the first aircraft 102, the probe 106, or both, based on the location and/or the estimated location, to engage the probe 106 with the drogue 114 to initiate refueling of the first aircraft 102.

Although FIGS. 1A-1E depict the first aircraft 102 including the sensor(s) 110, in some implementations the sensor(s) 110 are omitted or are not used to generate input to the additional processor(s) 111. For example, a location and/or an estimated location (e.g., of the drogue 114 or a portion thereof) may be determined solely based on thermal image data output by the thermal imaging sensor 104. Additionally, or alternatively, the vision processor 108 can perform one or more additional operations to identify or track the second aircraft 112 and/or the drogue 114, such as by using the sensor(s) 110.

The thermal imaging sensor 104 and the vision processor 108, in conjunction with other features of the first aircraft 102, improves efficiency (e.g., by reducing training costs), reliability, and repeatability of operations to mate the probe 106 and the drogue 114. For example, the vision processor 108 can process thermal image data generated by the thermal imaging sensor 104 to detect the location (e.g., the estimated location) of the drogue 114, or a portion thereof, without the cost and complexity of integrating other types of sensors in the first aircraft 102. Additionally, or alternatively, the location or the estimated location detected by the vision processor 108 can be used to support operations or functionality of other systems of the first aircraft 102, thereby improving the reliability and increasing confidence in detection and/or identification of the drogue 114 or a portion thereof. Such highly reliable detection is provided without significantly increasing the cost or complexity of the first aircraft 102, as the thermal imaging sensor 104 and the vision processor 108 represent a relatively small and low-cost portion of the overall processing resources and sensors onboard the first aircraft 102. The detection of the location of the drogue 114 or a portion thereof may be provided to the additional processor(s) 111, such as a guidance processor, which can mimic maneuvers performed by highly skilled human operators without the time and cost required to train the operators. Further, damage caused by improper maneuvers performed by automated aircraft or spacecraft can be reduced or eliminated by performing maneuvers that are determined based on the location or the estimated location of the drogue (or a portion thereof) output by the vision processor 108.

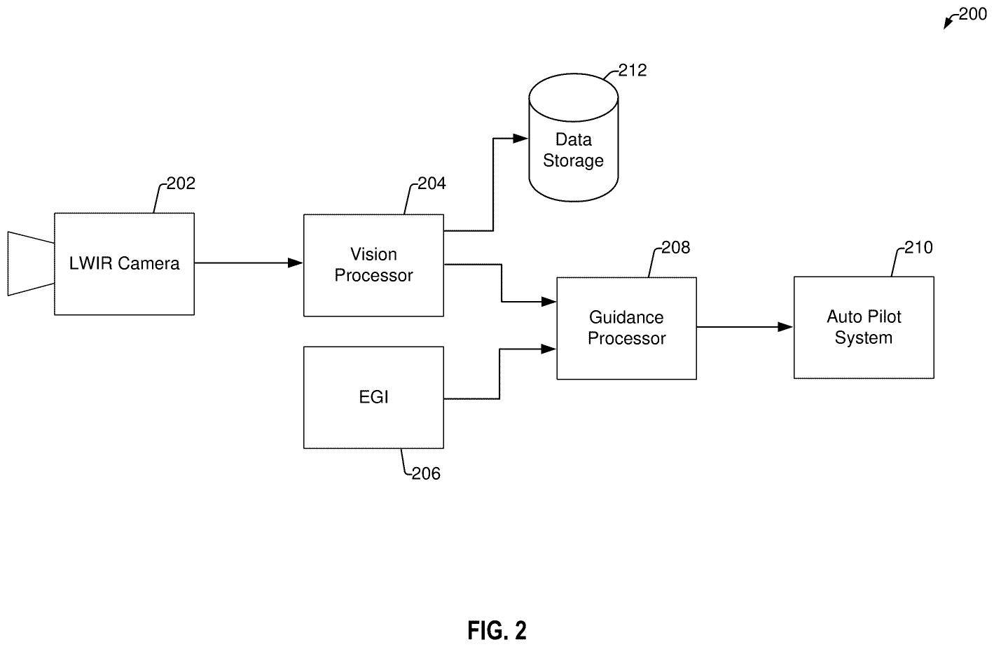

FIG. 2 is a diagram that illustrates a system 200 that is configured to detect or identify a location of a drogue. The system 200 is included in one or more devices, such as an autonomous or semi-autonomous aircraft or spacecraft. As an example, the system 200 can be included in or correspond to the first aircraft 102 of FIGS. 1A, 1D, and 1E. In the implementation shown in FIG. 2, the system 200 includes an LWIR camera 202, a vision processor 204, an optional embedded GPS-aided inertial navigation system (EGI) 206, a guidance processor 208, an auto pilot system 210, and optional data storage 212. The LWIR camera 202 is coupled to the vision processor 204, the vision processor 204 is coupled to the guidance processor 208 and the data storage 212, the EGI 206 is coupled to the guidance processor 208, and the guidance processor 208 is coupled to the vision processor 204, the EGI 206, and the auto pilot system 210. Although illustrated as being included in the system 200 in FIG. 2, in some other implementations, the EGI 206 is omitted from the system 200.

The LWIR camera 202 may include or correspond to the thermal imaging sensor 104. In some implementations, the LWIR camera 202 is configured to capture thermal images within a field of vision and to output thermal image data representing the thermal images to the vision processor 204. The thermal image data can depict temperature information of a captured scene, such as a portion of another aircraft or spacecraft that is within a particular range of the aircraft on which the system 200 is onboard. Although described as a LWIR camera, in other implementations, the LWIR camera 202 may additionally include, or be replaced with, any type of IR image capture device or thermal imaging device. Additionally, or alternatively, one or more other cameras, image capture devices, LED devices, or the like, may be similarly coupled to the vision processor 204 and configured to output respective image data or other types of data for use by the vision processor 204.

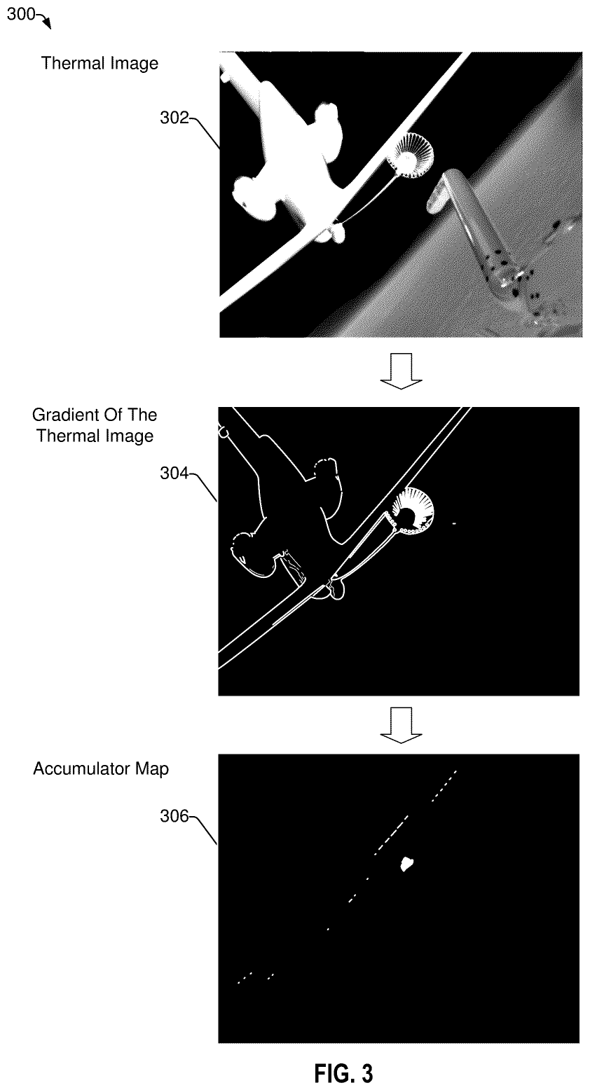

The vision processor 204 includes one or more processors, processor systems, CPUs, GPUs, and/or other hardware or circuitry, such as field-programmable gate arrays (FPGAs) or application-specific integrated circuits (ASICs), that are configured to process the thermal image data from the LWIR camera 202 (and optionally other data from other sensors) to identify and track another aircraft or spacecraft within a series of thermal images represented by the thermal image data. For example, the vision processor 204 may include or correspond to the vision processor 108. As described further herein with reference to FIGS. 3-7, the vision processor 204 can perform thermal image data processing/image processing to detect or identify a location or an estimated location of the drogue 114, or a portion thereof. Additionally, or alternatively, the vision processor 204 can process the thermal imaging data and or other data to identify, track, and/or determine a location or estimated location of position of a connector of the other aircraft, using other techniques described. In implementations in which the vision processor 204 determines multiple locations or estimated locations, other derived values, and/or other processed thermal image data, each such value or estimation may be associated with a confidence score generated by the vision processor 204. The vision processor 204 provides the estimates, derived values, and/or processed thermal image data, and optionally the confidence scores, to the guidance processor 208 for further processing and, optionally, to the data storage 212. Additionally, or alternatively, the data storage 212 may be configured to store dimension information associated with the drogue 114, such as a size of the drogue 114 (e.g., an aerial refueling basket). For example, the size may be a radius of the drogue 114.

The guidance processor 208, the EGI 206, or both, may include or correspond to the additional processor(s) 111. The guidance processor 208 includes one or more processors, processor systems, CPUs, GPUs, and/or other hardware or circuitry, such as FPGAs or ASICs, that are configured to process the output of the vision processor 204 and optional GPS and INS data received from the EGI 206 to determine one or more maneuvers to be performed by the aircraft on which the system 200 is onboard to cause the aircraft to mate a connector (e.g., the probe 106) with a connector (e.g., the drogue 114) of the other aircraft. The maneuvers can include navigation directions for the aircraft, movements for a probe or other arm or boom that controls the connector for the aircraft, engine control instructions, other maneuver-related information, or a combination thereof, that when executed by the auto pilot system 210, cause the aircraft to mate the connector to the corresponding connector of the other aircraft, such as during an aerial refueling operation or a docking operation between spacecraft. As a non-limiting example, the guidance processor 208 may output instructions to the auto pilot system 210 to cause the first aircraft 102 to mate the probe 106 with the drogue 114 of the second aircraft 112.

In implementations that include the data storage 212, the vision processor 204 may be configured to provide the various output (e.g., a location, an estimated location, gradient information, detection information, identification information, tracking information, processed thermal image data, etc.) to the data storage 212 for storage on the aircraft and/or transmission to another system or device. For example, the data storage 212 can include network or cloud storage that is wireless connected to the system 200 at various times. The output data from the vision processor 204 (the “vision output data”) may be used to train one or more artificial intelligence (AI) or machine learning (ML) models to automatically perform operations associated with the vision processor 204, the guidance processor 208, or a combination thereof. To illustrate, the vision output data can be provided as training data to an autonomous agent (e.g., an AI or ML model) to train the autonomous agent to estimate a location of the drogue 114, or a portion thereof, based on input thermal imaging data. In a particular aspect, image data (or features extracted therefrom) can be labeled with corresponding location data, estimated location data, or a combination thereof, to train the autonomous agent to estimate a location of the drogue 114 or a portion thereof based on non-labeled thermal image data received as an input. In another aspect, the image data (or features extracted therefrom) can be labeled with one or more maneuvers output by the guidance processor 208 to train the autonomous agent to, responsive to receiving unlabeled thermal image data, output maneuver instructions to cause the aircraft to mate the connector with the connector of the other aircraft. In a particular implementation, the trained autonomous agent includes or corresponds to a neural network. As an example, the neural network of the trained autonomous agent is trained using one or more reinforcement learning techniques. To illustrate, during a training phase, the reinforcement learning techniques may train the neural network based in part on a reward that is determined by comparing a proposed maneuver output by the neural network to an optimum or target maneuver in particular circumstances. In this context, the optimum or target maneuver may include, for example, a shortest or least cost maneuver to mate the connectors of the aircrafts; a maneuver that mimics a maneuver performed by one or more skilled human operators under similar circumstances; a maneuver that satisfies a set of safety conditions, such as not causing any undesired contact between portions of the aircrafts; a maneuver that corresponds to maneuvering characteristics specified during or before training; or a combination thereof. As another example, during a training phase, the reinforcement learning techniques may train the neural network based in part on a reward that is determined by comparing a location or estimated location output by the neural network to a measured location or a measured position of the drogue 114 (or a portion thereof) depicted in the image and based on the thermal image data.

In some implementations, the system 200 may include a display (not shown). The display may be coupled to the LWIR camera 202, the vision processor 204, the guidance processor 208, the auto pilot system 210, or a combination thereof. The display is configured to display one or more images, a representation of one or more operations performed by the vision processor 204, one or more operations performed by guidance processor 208, one or more operations performed by the auto pilot system 210, or a combination thereof.

Referring to FIGS. 3-7, examples of techniques to generate an accumulator map and/or identify a location or an estimated location of a portion of a drogue according to one or more aspects of the present disclosure are described. The techniques described with reference to FIGS. 3-7 may be initiated, performed, or controlled by one or more processors executing instructions, or by circuitry configured to cause performance of one or more operations, such as resides within the vision processor 108, the vision processor 204, a vision system 820, a vision system 932, one or more processors 1120, or a combination thereof. It is also noted that a technique described with reference to one of FIGS. 3-7 may combined with a technique of described with reference to another of FIGS. 3-7, or a combination thereof.

FIG. 3 depicts an example of a technique 300 to generate an accumulator map according to one or more aspects of the present disclosure. The technique 300 includes obtaining a thermal image 302 (e.g., represented by thermal image data from a thermal imaging sensor) that depicts at least a portion of a drogue. For example, the drogue may include or correspond to the drogue 114. In some implementations, the thermal image 302 includes an LWIR image captured by an LWIR camera.

The technique 300 also includes obtaining, based on the thermal image (e.g., the thermal image data), a gradient of at least a portion of the image. The portion of the image includes multiple pixels associated with multiple structures of the drogue. The gradient of an image can indicate a directional change in the intensity (e.g., temperature) of the thermal image. Stated in a different manner, the gradient of a thermal image can indicate a directional change in a temperature profile of a scene capture by a thermal imaging sensor (e.g., a thermal camera). In some implementations, the gradient of an image (or a portion of the image) is determined using an edge detection technique or an edge detector, such as a Sobel, Prewitt, Scharr, or other components from a Canny edge detector. For each pixel of the multiple pixels of the portion of the image, the gradient can include or indicate a value (e.g., a magnitude), a direction (e.g., an orientation of the magnitude), or a combination thereof. Additionally, the gradient can indicate or be used to determine an edge extension (e.g. a unit vector in the direction normal to the direction of maximum intensity change), and/or an edge direction (e.g., a unit vector along an edge and which is perpendicular to the edge extension). A representation of edge strength values (e.g., magnitudes) of the gradient of the thermal image 302 is shown at 304. In some implementations, obtaining the gradient includes performing one or more thresholding operations (e.g., one or more filtering operations) on the gradient. For example, the gradient can be filtered to remove points that have a weak gradient magnitude (e.g., have a gradient magnitude value that fails to satisfy a threshold) and/or are adjacent to points with a higher local maximum.

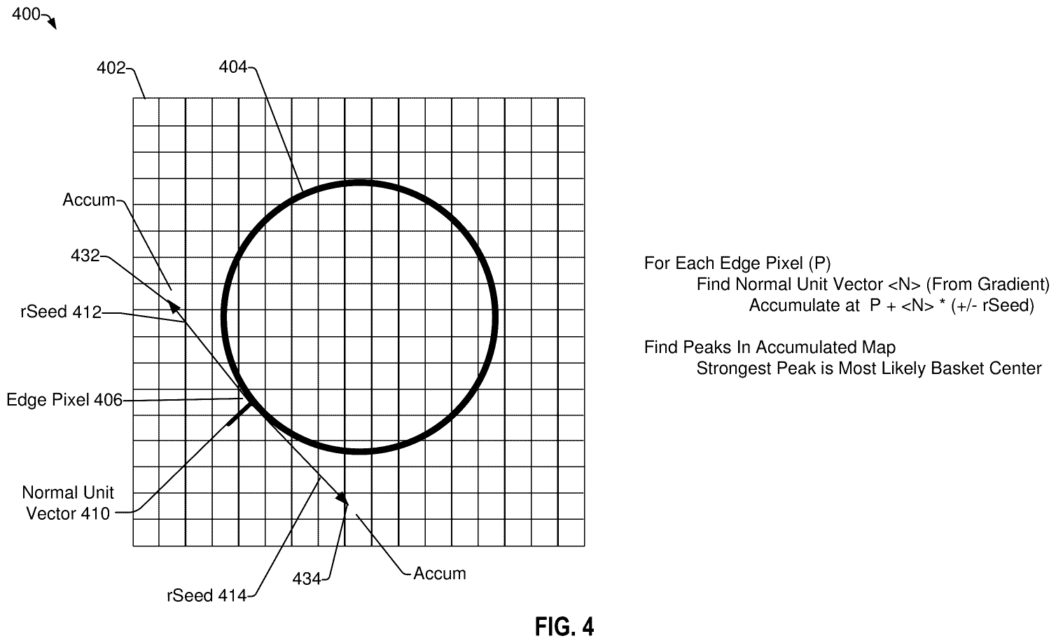

The technique 300 includes generating and/or populating an accumulator map 306 based on the gradient. The accumulator map 306 represents a probability map that any given pixel (e.g., point) in the thermal image 302 is a center of the drogue (e.g., a refueling basket). Techniques and/or operations to generate and/or populate the accumulator map are described further herein at least with reference to FIGS. 4-8. A resolution of the accumulator map 306 can correspond to a number of cells of the accumulator map 306, and a resolution of the thermal image 302 can include or correspond to a number of pixels of the thermal image 302 or of the portion of the thermal image 302. The accumulator map 306 can have a resolution that is less than or equal to a resolution of the thermal image 302 or a portion of the thermal image 302.

FIG. 4 depicts an example of another technique 400 to generate an accumulator map according to one or more aspects of the present disclosure. The technique 400 is described with reference to a representation of a gradient of an image that includes multiple pixels. As shown in FIG. 4, the representation of the gradient of the image includes pixels, such as a representative pixel 402, and is based on thermal image data. For example, the thermal image data can include or correspond to the thermal image 302, and the gradient can include or indicate a directional change in the intensity or temperature of a thermal image. Each pixel of the gradient includes a corresponding edge strength value (e.g., a magnitude) and a corresponding direction (e.g., an orientation or vector). In some implementations, a thresholding operation is performed on the gradient to filter one or more pixels of the gradient prior to further processing. It is noted that the gradient can represent an edge of an object in a thermal image, such as an edge of a drogue or an edge of an aircraft or spacecraft. As shown in FIG. 4, the gradient indicates an edge 404.

The technique 400 includes, for each pixel in the gradient (e.g., the edge 404) that has a magnitude that satisfies (e.g., is greater than or equal to) a threshold, determining a gradient normal (“<N>”) of the pixel. To illustrate, for edge pixel 406 in the gradient image, a gradient normal 410 (<N>) is determined. The gradient normal of a pixel is a unit vector perpendicular to the direction of maximum intensity change from the pixel to an adjacent pixel (e.g., the gradient normal is a vector that is perpendicular to the gradient direction for the pixel and parallel to the edge pixel). In some implementations, the gradient normal (<N>) of a pixel may be determined based on gradient information from the pixel, such as based on a direction included in the gradient.

Next, for each pixel in the gradient (e.g., the edge 404) that has a magnitude that satisfies (e.g., is greater than or equal to) the threshold, a vector (e.g., +/−rSeed*<N>) is projected from the pixel (P) that is orthogonal to the unit gradient vector 410 at that pixel. To illustrate, for the edge pixel 406, a vector 412 and a vector 414 are projected from the edge pixel 406. It is noted that the vectors 412, 414 are projected in opposing directions from the edge pixel 406, such as the vector 412 being projected at a +90 degree angle from the edge normal (i.e., the gradient normal 410 (<N>)) and the vector 414 being projected at a −90 degree angle from the edge normal (i.e., the gradient normal 410 (<N>)). A dimension (e.g., a length or distance) of the vectors 412, 414 (+/−rSeed) can be set to be equal to or approximately equal to the radius of the drogue 114 expected to be used during a refueling operation +/− some uncertainty that can allow multiple cells to accumulate along a portion of the vector. In some implementations, the dimension of the vectors 412, 414 (+/−rSeed) are set to be equal to the radius of the drogue 114 expected to be used during a refueling operation.

An accumulator map, such as the accumulator map 306, is generated and populated based on the projected vectors (+/−rSeed) (e.g., vectors 412, 414) for each pixel. To illustrate, the projected vectors can be overlaid on the accumulator map, and the accumulator map can be populated based on at least a portion of the projected vectors (+/−rSeed). For example, the accumulator map can include multiple cells and each cell can include or be associated with a value that represents a number of projected vectors (+/−rSeed) that overlap the cell. In some implementations, a cell (Accum) of the accumulator map is incremented based on an endpoint (e.g., 432 or 414) of a projected vector (+/−rSeed) being in the cell. Additionally, or alternatively, a value of a cell of the accumulator map can be incremented based on the presence of a portion of a vector or an entirety of a vector in the cell.

A peak value in the accumulator map indicates a likely location of the center of the drogue 114. To illustrate, when vectors (+/−rSeed) are projected for pixels that correspond to the structures 166 of drogue 114, multiple projected vectors (+/−rSeed) should overlap at a location associated with the center of the drogue 114. This location should be within a cell of the accumulator map, resulting in the cell having a larger value (e.g., a peak value) than other cells of the accumulator map. Accordingly, a peak value in the accumulator map occurs at a point-of-convergence of multiple vectors (+/−rSeed) and is an indication of the center that can be used to positively identify and/or track the drogue 114 in a sequence of images (e.g., thermal images or non-thermal images).

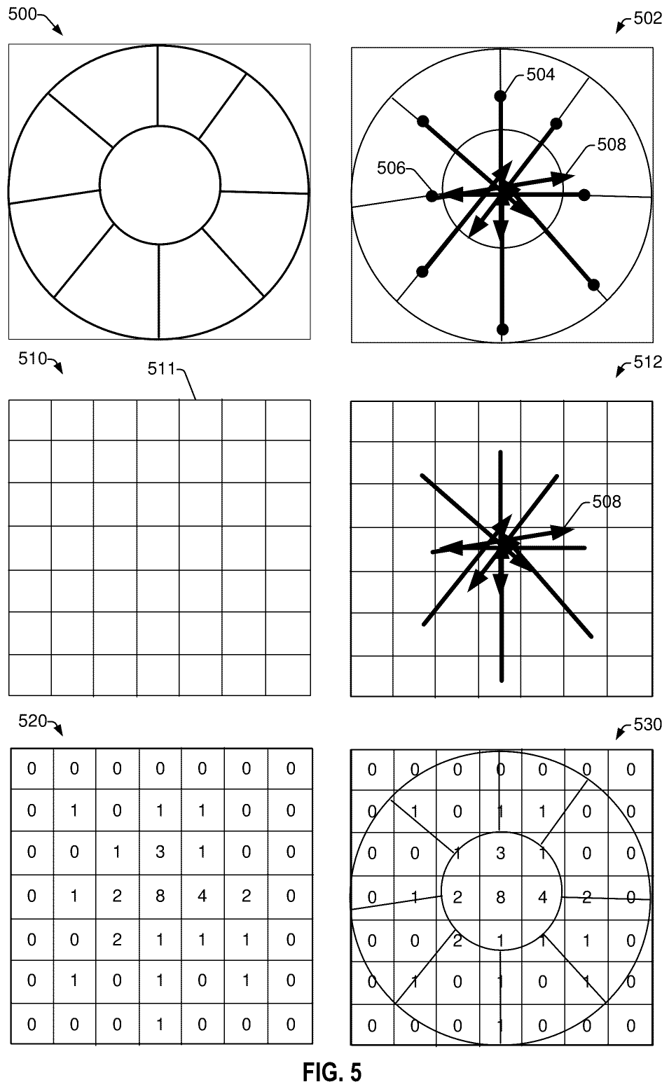

FIG. 5 depicts an example of a technique to identify a location of a drogue according to one or more aspects of the present disclosure. At a first stage 500 of the technique of FIG. 5, a representation of a gradient of a thermal image (e.g., thermal image data) is generated. The thermal image may include or correspond to the thermal image 302 of FIG. 3. The thermal image may have a resolution that is based on a number of pixels included in the thermal image.

At a second stage 502 of the technique of FIG. 5, the gradient is filtered to identify a set of pixels, such as representative pixels 504 and 506. For each pixel of the set of pixels, a vector (e.g., rSeed) is projected in an edge direction which is orthogonal to the edge normal of the pixel. To illustrate, with reference to the pixel 506, a vector 508 is projected from the pixel 506. As described above, the edge normal is in the same direction as the gradient direction of the pixel.

At a third stage 510 of the technique of FIG. 5, an accumulator map is generated. The accumulator map includes multiple cells, such as representative cell 511. A resolution of the accumulator map is based on a number of cells included in the accumulator map. The resolution of the accumulator map may be less than or equal to the resolution of the thermal image. When the accumulator map is generated, a value of each cell of the accumulator map can be initialized to an initial value, such as zero (not shown at the third stage 510).

At a fourth stage 512 of the technique of FIG. 5, the accumulator map is populated based on the vectors (e.g., the vector 508) projected from each pixel of the set of pixels of the gradient. For example, the vectors from the second stage 502 can be overlaid on the accumulator map from the third stage 510, and cells of the accumulator map are populated to indicate a number of vectors (or portions thereof) that overlay the respective cells. In some implementations, a value of each cell is incremented based on each vector that is included in (has at least a portion of the vector) in the cell. For example, a cell in which two vectors are overlaid can be incremented twice to a value of two, a cell in which a single vector is overlaid can be incremented once to a value of one, and a cell in which no vectors are overlaid can be set at (or remain at) an initial value of zero.

At a fifth stage 520 of the technique of FIG. 5, a resultant accumulator map is determined after incrementing one or more cells of the accumulator map based on the vectors. At a sixth stage 530 of the technique of FIG. 5, an estimate of a location of a center of the drogue 114 is determined based on a peak value of the accumulator map. In the example shown in FIG. 5, the estimated center includes or corresponds to the cell of the accumulator map having the value of “8”, which is the largest value of any cell in the accumulator map. It is noted that the sixth stage 530 is shown with the gradient of the first stage 500 overlaid on top of the resultant accumulator map of the fifth stage 520 to illustrate the estimated center in relation to the drogue 114.

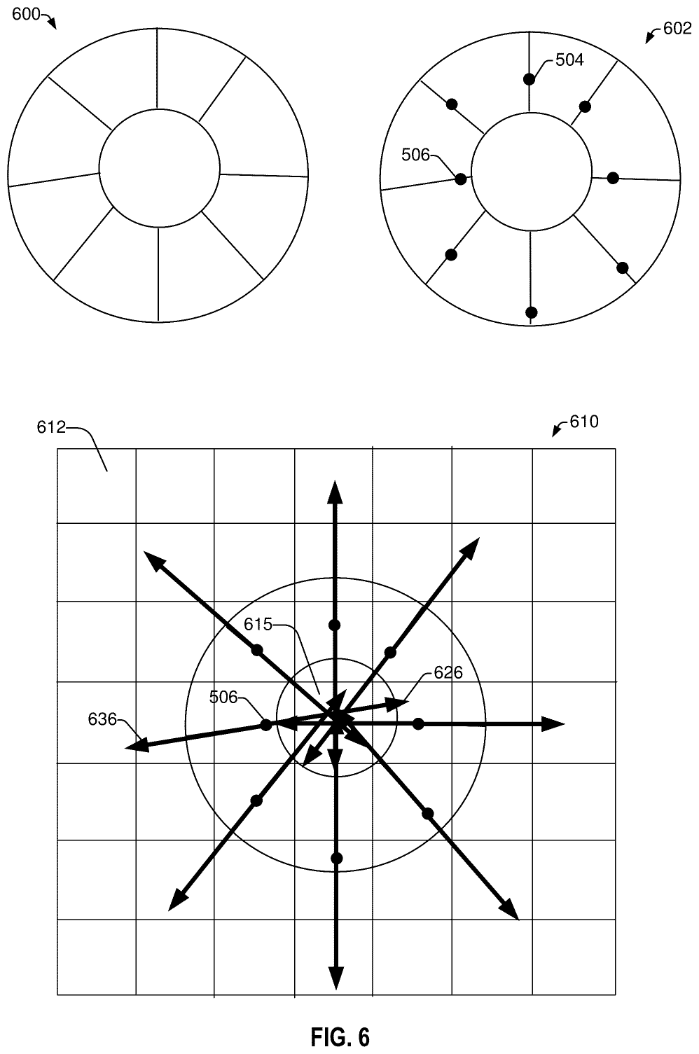

FIG. 6 depicts an example of another technique to identify a location of a drogue according to one or more aspects of the present disclosure. At a first stage 600 of the technique of FIG. 6, a gradient of a thermal image (e.g., thermal image data) is generated. The first stage 600 can include or correspond to the first stage 500 of the technique of FIG. 5.

At a second stage 602 of the technique of FIG. 6, the gradient is filtered to identify a set of pixels, such as representative pixels 504 and 506. The second stage 602 of the technique of FIG. 6 can include or correspond to the second stage 502 of the technique of FIG. 5.

At a third stage 610 of the technique of FIG. 6, for each pixel of the set of pixels, a vector (e.g., rSeed) is projected in both positive and negative edge directions of the pixel, which are orthogonal to the edge normal of the pixel. For example, with reference to the representative pixel 506 in FIG. 6, the vector (e.g., rSeed), projected in both positive and negative edge directions, includes a first vector 626 and a second vector 636 projected in an opposite direction from the first vector 626. It is noted that the third stage 610 is shown with the gradient and set of pixels of the second stage 602, along with the vectors 626, 636 (e.g., rSeed) overlaid on top of an accumulator map having representative cell 612. As shown in FIG. 6, an estimated location of a center of the drogue 114 that is determined based on a convergence of the vectors (e.g., rSeed) includes or corresponds to cell 615 of the accumulator map that is overlaid with the most vectors, or portions thereof.

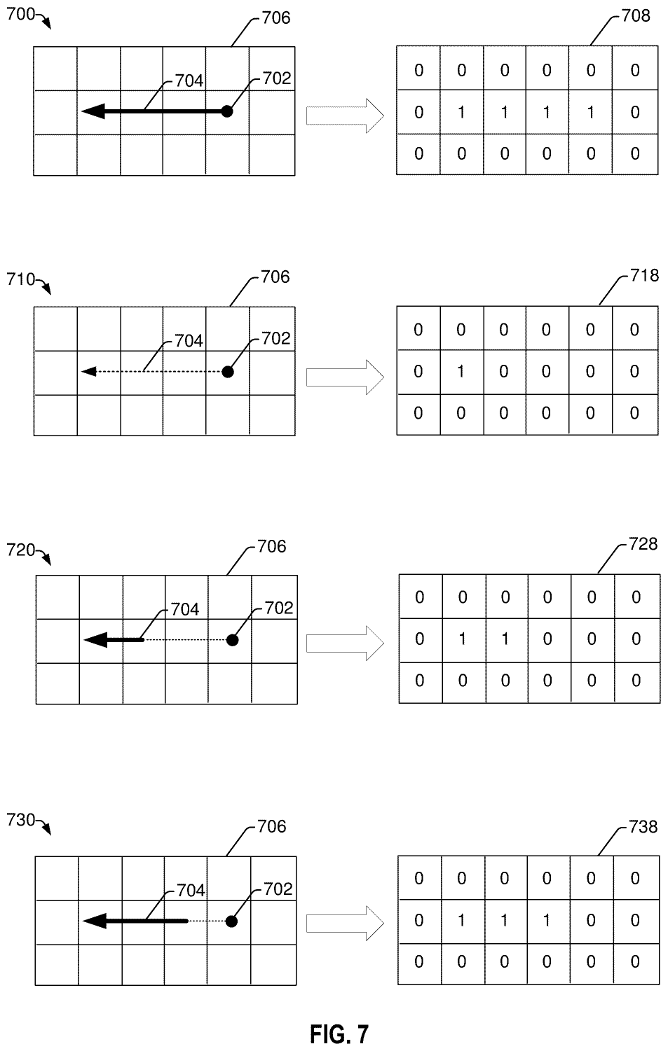

FIG. 7 depicts examples of other techniques to identify a location of a drogue according to one or more aspects of the present disclosure. Specifically, FIG. 7 depicts examples of projected vectors and accumulator maps populated based on the projected vector.

A first example 700 shows a vector 704 projected from a pixel 702. The pixel 702 may include or correspond to the pixel 504 or 506. The vector 704 may include or correspond to the vector 508, 626, or 636 or the vector rSeed. Additionally, an accumulator map 706 is overlaid on top of the pixel 702 and the projected vector 704. The accumulator map 706 may include or correspond to the accumulator map 306.

The first example 700 also shows the accumulator map 706 after the accumulator map 706 is populated based on the vector 704 to generate a populated accumulator map 708. As shown, the cells of the populated accumulator map 708 have been populated to indicate a number of vectors that overlay the respective cells. In the first example 700, each cell that includes any portion of the vector 704 is incremented to indicate that at least a portion of the vector 704 overlays the respective cell.

A second example 710 also shows the pixel 702, the projected vector 704, and the accumulator map 706. As compared to the first example 700, the projected vector 704 of the second example 710 is dashed. The dashed portion of the projected vector 704 will not be used to populate the accumulator map 706; rather, the accumulator map 706 will be populated based on an endpoint (e.g., the arrow tip) of the projected vector 704. Accordingly, the second example 710 also shows the accumulator map 706 after the accumulator map 706 is populated based on the vector 704 to generate a populated accumulator map 718. As shown, the cells of the populated accumulator map 718 have been populated to indicate a number of vectors having an endpoint (e.g., the arrow tip) that overlay the respective cell. In the second example 710, the pixel 702 is not considered an endpoint of the vector 704.

A third example 720 also shows the pixel 702, the projected vector 704, and the accumulator map 706. As compared to the first example 700 and the second example 710, a portion the projected vector 704 of the third example 720 is dashed and a portion of the projected vector 704 of the third example 720 is solid. The dashed portion of the projected vector 704 will not be used to populate the accumulator map 706; rather, the accumulator map 706 will be populated based on the solid portion of the projected vector 704. Accordingly, the third example 720 also shows the accumulator map 706 after the accumulator map 706 is populated based on the vector 704 to generate a populated accumulator map 728. As shown, the cells of the populated accumulator map 728 have been populated to indicate a number of vectors having the solid portion of the vector that overlay the respective cell.

A fourth example 730 also shows the pixel 702, the projected vector 704, and the accumulator map 706. A portion the projected vector 704 of the fourth example 730 is dashed and a portion of the projected vector of the fourth example 730 is solid. As compared to dashed portion and the solid portion of the projected vector 704 of the third example 720, the dashed portion and the solid portion of the projected vector 704 of the fourth example 730 are different lengths than the corresponding portions of the projected vector 704 of the third example 720. The dashed portion of the projected vector 704 will not be used to populate the accumulator map 706; rather, the accumulator map 706 will be populated based on the solid portion of the projected vector 704. Accordingly, the fourth example 730 also shows the accumulator map 706 after the accumulator map 706 is populated based on the vector 704 to generate a populated accumulator map 738. As shown, the cells of the populated accumulator map 738 have been populated to indicate a number of vectors having the solid portion of the vector that overlay the respective cell.

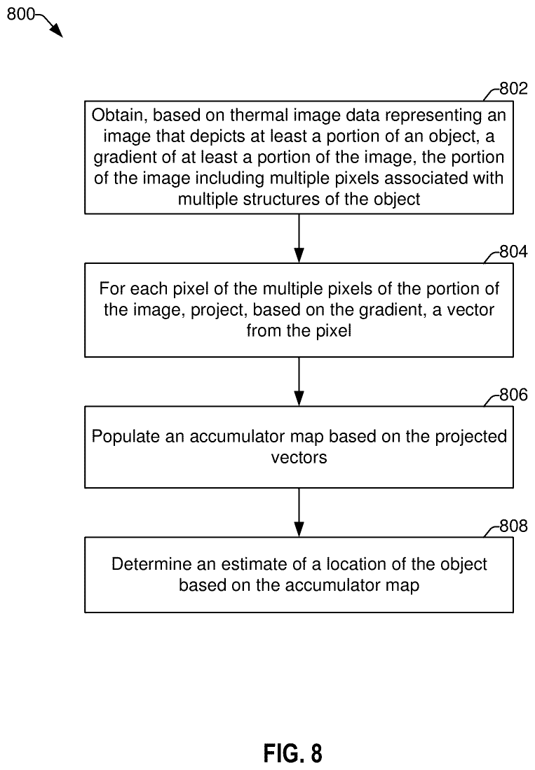

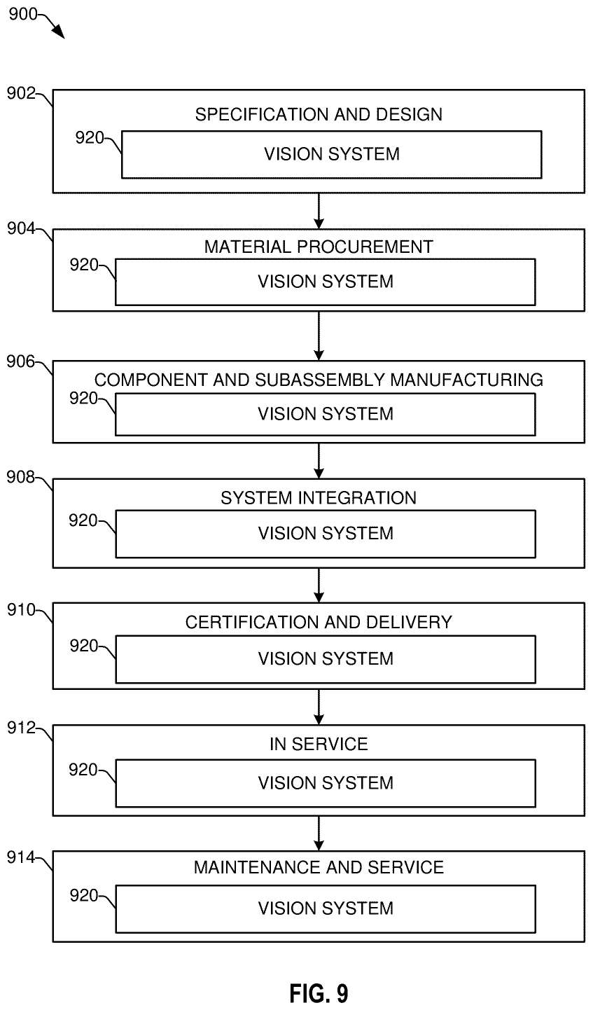

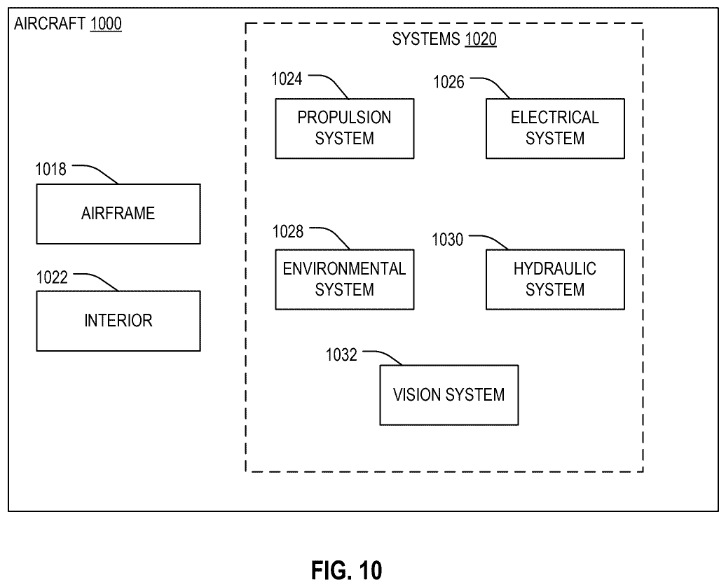

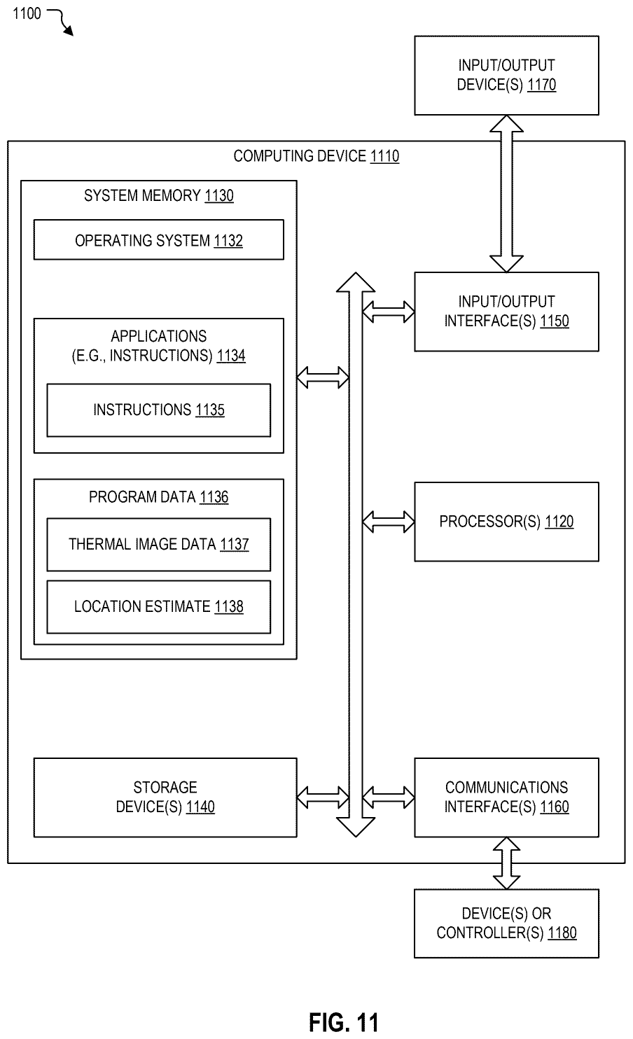

FIG. 8 is a flowchart that illustrates an example of a method 800 of identifying a location of an object according to one or more aspects of the present disclosure. In some implementations, the object may be a drogue. The method 800 can be initiated, performed, or controlled by one or more processors executing instructions, or by circuitry configured to cause performance of one or more operations, such as resides within the vision processor 108 of FIG. 1A, the vision processor 204 of FIG. 2, a vision system 920 of FIG. 9, a vision system 1032 of FIG. 10, one or more processors 1120 of FIG. 11, or a combination thereof. The one or more processors may be included in a device, such as the first aircraft 102. In some implementations, the device includes an autonomous or semi-autonomous air or space vehicle.

In some implementations, the method 800 includes, at block 802, obtaining, based on thermal image data representing an image that depicts at least a portion of an object, a gradient of at least a portion of the image. The portion of the image can include multiple pixels associated with multiple structures of the object. For example, the thermal image data can include or correspond to thermal image 302. In some implementations, the thermal image data includes long-wave infrared image data, the thermal image data depicts at least a portion of the object, or a combination thereof. The gradient can include, for each pixel of the multiple pixels of the image or the portion of the image, an edge strength value (e.g., a gradient magnitude), a vector, a direction (e.g., an orientation), or a combination thereof. For example, the gradient may be associated with the representation of the gradient shown at 304 of FIG. 3. The multiple structures of the object can include or correspond to the structures 166 of the drogue 114. In some implementations, the gradient can indicate one or more edges detected in the image and each pixel of the multiple pixels can correspond to a detected edge.

In some implementations, the method 800 includes generating the gradient. For example, the vision processor 108 or 204 can calculate the gradient of the portion of the image. Additionally, or alternatively, the method 800 can include filtering the gradient to determine the multiple pixels. For example, to filter the portion of the image, the vision processor 108 or 204 can, for each pixel of the multiple pixels of the portion of the image, perform a comparison based on the gradient magnitude value (from the gradient) of the pixel and a gradient threshold. To illustrate, filtering can be performed such that each pixel of the multiple pixels has the gradient magnitude value (from the gradient) of the pixel that is greater than or equal to the gradient threshold may be included in the filtered gradient. As another example, to filter the portion of the image to determine the multiple pixels, the vision processor 108 or 204 can discard each pixel of the portion of the image having a respective edge strength value (from the gradient) that is less than the edge strength value (from the gradient) of an adjacent pixel to the pixel. It is noted that the edge strength value (from the gradient) of a pixel may also be referred to herein as a gradient magnitude value of the pixel.

The thermal image data can be generated by a thermal imaging sensor, such as the thermal imaging sensor 104 or the LWIR camera 202. In some implementations, the vision processor 108 or 204 is configured to obtain (e.g., receive) the thermal image data, such as from the thermal imaging sensor. The thermal image data can be stored at a memory, such as the data storage 212.

The object can include or correspond to the drogue 114, as an illustrative, non-limiting example. The object can be coupled to an aircraft via a hose. To illustrate, the drogue 114 can be coupled to the second aircraft 112 via the hose 116. The object includes a socket (e.g., the reception coupling 160) configured to be coupled to a probe, such as the probe 106 of the first aircraft 102.

The portion of the image can include multiple pixels associated with multiple structures of the object. The structures can include or correspond to the structures 166. In some implementations, the multiple structures of the object include multiple spokes (e.g., arms) that extend radially away from a center of the object. The center of the object can correspond to a center of the socket (e.g., the reception coupling 160), such as the center of an opening defined by the socket and configured to receive the probe 106. In some implementations, the center of the object is associated with a point-of-convergence of the multiple structures of the object. To illustrate, when the object is viewed from an end, the multiple structures can appear to converge at the center.

The method 800 also includes, at block 804, for each pixel of the multiple pixels, projecting, based on the gradient, a vector from the pixel. To illustrate, the vision processor 108 or 204 can project a vector from each pixel. For example, the vector may include or correspond to the vectors 412, 414, 508, 626, or 636.

In some implementations, for each pixel of the multiple pixels of the portion of the image, the vector is projected from the pixel based on the direction (e.g., included in the gradient of the pixel) of the pixel. The vector can be projected to be orthogonal to the direction (e.g., orthogonal to an edge normal vector) corresponding to the pixel. For example, to project the vector from the pixel, an edge normal vector (gradient) of the pixel can be identified, and a first vector is projected from the pixel at 90 degrees with respect to the edge normal vector, a second vector is projected from the pixel at −90 degrees with respect to the edge normal vector, or a combination thereof. The projected vector can have a length that is based on a dimension or size associated with the object. For example, the size can be the same as or proportional to a radius of the object (e.g., a size of a radius of the drogue 114 at the canopy 168 or at the center of the socket). A size of the object can be indicated by or determined based on size information stored at an optional memory, such as the data storage 212.

The method 800 includes, at block 806, populating one or more cells of an accumulator map based on the projected vectors. To illustrate, the vision processor 108 or 204 can generate and/or populate one or more cells of the accumulator map. For example, the accumulator map can include or correspond to the accumulator map 306 or the accumulator map at the fifth stage 520. In some implementations, the accumulator map includes a set of cells associated with the portion of the image. A representative cell of the set of cells can include or correspond to cell 511.

To populate the accumulator map, the method 800 can, for each vector of the projected vectors, populate the accumulator map based on at least a portion of the vector. To illustrate, the accumulator map can be populated based on an end point of the vector, a line segment of the vector, or an entirety of the vector. The accumulator map can be populated based on a cell of the accumulator map including at least the portion of the vector. In some implementations, a resolution of the accumulator map is the same or lower than a resolution of the image. For example, a resolution of the accumulator map can correspond to a number of cells of the accumulator map, and a resolution of the image can include or correspond to a number of pixels of the image or of the portion of the image.

The method 800 includes, at block 808, determining an estimate of a location (e.g., the center) of the object based on the accumulator map. For example, the estimate of the location can include or correspond to a peak value of the accumulator map. In some implementations, the method 800 includes identifying and/or tracking the object based on the estimate.

In some implementations, the method 800 includes determining a candidate of the estimate based on the accumulator map. The method 800 can include determining a score of the candidate based on characteristic information, the peak value of the accumulator map, or a combination thereof. Additionally, or alternatively, the method 800 can include performing a blob characterization operation on the accumulator map to generate the characteristic information. To illustrate, the characteristic information can include or indicate a blob center (e.g., in a horizontal direction, a vertical direction, or both), a score or confidence weight, a count of a number of pixels in the blob, a blob bounding box dimension (e.g., a width, a height, a radius, or a combination thereof), a blob aspect ratio, a blob density, a blob de-center (e.g., a distance form a highest pixel in the blob to a center of mass), an angle between the center of mass and a further blob extent, or a combination thereof, as illustrative, non-limiting examples. The method 800 can include selecting, based on a score and/or the characteristic information associated with the candidate, the candidate for use as the estimate of the center of the object. In some implementations, the method 800 determines multiple candidates of the estimate and selects one or more candidates as the estimate of the center.

In some implementations, the method 800 includes controlling an autonomous aerial refueling operation based on the estimate of the center. For example, the auto pilot system 210 can be configured to control the autonomous aerial refueling operation. During the autonomous aerial refueling operation, the probe is coupled to the object and, when coupled to the object, receives fuel via the object.

The method described above with reference to FIG. 8 can be implemented to realize one or more of the technical advantages described in more detail above. For example, the method 800 can enable performing thermal image-based detection or identification, such as detection or identification of a location of an object, such as a drogue, in images. To illustrate, the method 800 can enable detection of the object (e.g., a refueling basket) based on a configuration of structures (e.g., spokes) of the object and based on a gradient of a thermal image and an accumulator map that is populated based on vectors projected based on the gradient. The method 800 can also enable detection of a location of a socket (configured to be coupled to a probe) of the object. Additionally, the method 800 can enable probe and object aerial refueling of an autonomous or semi-autonomous aircraft, such as probe and drogue aerial refueling of the autonomous or semi-autonomous aircraft. For example, detection of a candidate location of an object can be used to identify and verify a location of the object, which can then be tracked and used to perform an aerial refueling of an autonomous or semi-autonomous aircraft.

Referring to FIG. 9, a flowchart illustrative of an example of a life cycle of an aircraft that includes a vision system configured to identify a location of an object is shown and designated 900. For example, the aircraft may include or correspond to the first aircraft 102. The vision system may include or correspond to the vision processor 108 or 204, and the object may include or correspond to the drogue 114.

During pre-production, the exemplary method 900 includes, at 902, specification and design of an aircraft, such as the first aircraft 102 described with reference to FIGS. 1A-1E. During specification and design of the aircraft, the method 900 can include specification and design of a vision system 920 that is configured to identify the location of the object. The vision system 920 may include one or more components of the system 100 or 200. In some implementations, the vision system 920 includes or corresponds to the vision processor 108 or 204. At 904, the method 900 includes material procurement, which can include procuring materials for the vision system 920.

During production, the method 900 includes, at 906, component and subassembly manufacturing and, at 908, system integration of the aircraft. For example, the method 900 can include component and subassembly manufacturing of the vision system 920 and system integration of the vision system 920. At 910, the method 900 includes certification and delivery of the aircraft and, at 912, placing the aircraft in service. Certification and delivery can include certification of the vision system 920 to place the vision system 920 in service. While in service by a customer, the aircraft can be scheduled for routine maintenance and service (which can also include modification, reconfiguration, refurbishment, and so on). At 914, the method 900 includes performing maintenance and service on the aircraft, which can include performing maintenance and service on the vision system 920.

Each of the processes of the method 900 can be performed or carried out by a system integrator, a third party, and/or an operator (e.g., a customer). For the purposes of this description, a system integrator can include without limitation any number of aircraft manufacturers and major-system subcontractors; a third party can include without limitation any number of venders, subcontractors, and suppliers; and an operator can be an airline, leasing company, military entity, service organization, and so on.

Aspects of the disclosure can be described in the context of an example of a vehicle. A particular example of a vehicle is an aircraft 1000 as shown in FIG. 10. For example, the aircraft 1000 may include or correspond to the first aircraft 102. The aircraft 1000 can be a drone aircraft or any type of autonomous or semi-autonomous aircraft or spacecraft. In the example of FIG. 10, the aircraft 1000 includes an airframe 1018 with a plurality of systems 1020 and an interior 1022. Examples of the plurality of systems 1020 include one or more of a propulsion system 1024, an electrical system 1026, an environmental system 1028, a hydraulic system 1030, and a vision system 1032. Any number of other systems can be included and/or one or more of the systems depicted in FIG. 10 may be omitted. In the example of FIG. 10, the vision system 1032 is configured to provide thermal image-based identification (e.g., of a location of an object) functionality and can include or correspond to the system 100, the thermal imaging sensor 104, the vision processor 108, the system 200, the LWIR camera 202, the vision processor 204, the vision system 920, or any combination thereof.

FIG. 11 is a block diagram of a computing environment 1100 including a computing device 1110 configured to support aspects of computer-implemented methods and computer-executable program instructions (or code) according to the present disclosure. For example, the computing device 1110, or portions thereof, is configured to execute instructions to initiate, perform, or control one or more operations described with reference to FIGS. 1A-1E or 2-10.

The computing device 1110 includes one or more processors 1120. The processor(s) 1120 are configured to communicate with system memory 1130, one or more storage devices 1140, one or more input/output interfaces 1150, one or more communications interfaces 1160, or any combination thereof. The system memory 1130 includes volatile memory devices (e.g., random access memory (RAM) devices), nonvolatile memory devices (e.g., read-only memory (ROM) devices, programmable read-only memory, and flash memory), or both. The system memory 1130 stores an operating system 1132, which can include a basic input/output system for booting the computing device 1110 as well as a full operating system to enable the computing device 1110 to interact with users, other programs, and other devices. The system memory 1130 stores system (program) data 1136, such as thermal image data 1137, location estimate 1138 (e.g., of an object), or a combination thereof. The thermal image data 1137 can include or correspond to thermal image data generated by the thermal imaging sensor 104 or the LWIR camera 202. The location estimate 1138 can include or correspond to an estimated location or center of the drogue 114 generated by the vision processor 108 or 204, or the vision system 920.

The system memory 1130 includes one or more applications 1134 (e.g., sets of instructions) executable by the processor(s) 1120. As an example, the one or more applications 1134 include instructions executable by the processor(s) 1120 to initiate, control, or perform one or more operations described with reference to FIGS. 1A-1E or 2-11. To illustrate, the one or more applications 1134 include instructions 1135 executable by the processor(s) 1120 to initiate, control, or perform one or more operations described with reference to the vision processor 108 or 204, or the vision system 920.

In a particular implementation, the system memory 1130 includes a non-transitory, computer readable medium storing the instructions 1135 that, when executed by the processor(s) 1120, cause the processor(s) 1120 to initiate, perform, or control operations to perform thermal image-based identification (e.g., of a location of an object) functionality to enable or support one or more operations of an autonomous vehicle. For example, the operations may include one or more operations as described with reference to at least FIG. 8. Additionally, or alternatively, the operations can include obtaining, based on thermal image data of an image depicting at least a portion of an object, a location associated with a point-of-convergence of multiple structures of the object. The operations can further include identifying the object based on the location.

The one or more storage devices 1140 include nonvolatile storage devices, such as magnetic disks, optical disks, or flash memory devices. In a particular example, the storage devices 1140 include both removable and non-removable memory devices. The storage devices 1140 are configured to store an operating system, images of operating systems, applications (e.g., one or more of the applications 1134), and program data (e.g., the system program data 1136). In a particular aspect, the system memory 1130, the storage devices 1140, or both, include tangible computer-readable media. In a particular aspect, one or more of the storage devices 1140 are external to the computing device 1110.

The one or more input/output interfaces 1150 enable the computing device 1110 to communicate with one or more input/output devices 1170 to facilitate user interaction. For example, the one or more input/output interfaces 1150 can include a display interface, an input interface, or both. For example, the input/output interface 1150 is adapted to receive input from a user, to receive input from another computing device, or a combination thereof. In some implementations, the input/output interface 1150 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 1170 includes one or more user interface devices and displays, including some combination of buttons, keyboards, pointing devices, displays, speakers, microphones, touch screens, and other devices.

The processor(s) 1120 are configured to communicate with devices or controllers 1180 via the one or more communications interfaces 1160. For example, the one or more communications interfaces 1060 can include a network interface. The devices or controllers 1180 can include, for example, a controller for the probe 106, one or more other devices, or any combination thereof.

In some implementations, a non-transitory, computer readable medium stores instructions that, when executed by one or more processors, cause the one or more processors to initiate, perform, or control operations to perform part or all of the functionality described above. For example, the instructions can be executable to implement one or more of the operations or methods of FIGS. 1A-1E or 2-11, or a combination thereof. In some implementations, part or all of one or more of the operations or methods of FIGS. 1A-1E or 2-11, or a combination thereof, can be implemented by one or more processors (e.g., one or more central processing units (CPUs), one or more graphics processing units (GPUs), one or more digital signal processors (DSPs), one or more field-programmable gate arrays (FPGAs), or one or more application-specific integrated circuits (ASICs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations may be apparent to those of skill in the art upon reviewing the disclosure. Other implementations may be utilized and derived from the disclosure, such that structural and logical substitutions and changes may be made without departing from the scope of the disclosure. For example, method operations may be performed in a different order than shown in the figures or one or more method operations may be omitted. Accordingly, the disclosure and the figures are to be regarded as illustrative rather than restrictive.

Aspects of the disclosure are described further with reference to the following set of interrelated examples:

According to Example 1, a device includes a vision processor. The vision processor is configured to: obtain, based on thermal image data representing an image depicting at least a portion of an object, a gradient of at least a portion of the image, the portion of the image including multiple pixels associated with multiple structures of the object; for each pixel of the multiple pixels of the portion of the image, project, based on the gradient, a vector from the pixel; populate an accumulator map based on the projected vectors; and determine an estimate of a center of the object based on the accumulator map.

Example 2 includes the device of Example 1, where the vision processor is further configured to receive the thermal image data.

Example 3 includes the device of Example 1 or Example 2, where the multiple structures of the object include multiple spokes that extend radially away from the center of the object.

Example 4 includes the device of any one of Examples 1-3, where the vision processor is further configured to calculate the gradient of the portion of the image.

Example 5 includes the device of any one of Examples 1-4, where, for each pixel of the multiple pixels of the portion of the image, the gradient includes a gradient magnitude value, a vector, a direction, or a combination thereof.

Example 6 includes the device of Example 5, where, for each pixel of the multiple pixels of the portion of the image, the gradient includes the gradient magnitude value and the vector or direction.

Example 7 includes the device of Example 5 or Example 6, where, for each pixel of the multiple pixels of the portion of the image, the vision processor is configured to project the vector from the pixel based on the direction the gradient at the pixel.

Example 8 includes the device of Example 5 or Example 6, where the vision processor is further configured to filter the gradient to determine the multiple pixels.

Example 9 includes the device of Example 8, where, to filter the gradient, the vision processor is configured to, for each pixel of the multiple pixels of the portion of the image, perform a comparison based on the gradient magnitude value of the pixel and a gradient threshold.

Example 10 includes the device of Example 9, where, after the portion of the image is filtered, each pixel of the multiple pixels has the gradient magnitude value of the pixel that is greater than or equal to the gradient threshold.

Example 11 includes the device of any one of Examples 8-10, where, to filter the portion of the image to determine the multiple pixels, the vision processor is configured to discard each pixel of the portion of the image having a respective gradient magnitude value that is less than the gradient magnitude value of an adjacent pixel to the pixel.

Example 12 includes the device of any one of Examples 1-11, where the vector is orthogonal to an edge normal vector.

Example 13 includes the device of any one of Examples 1-12, where the vector has a length that is based on a size of the object.

Example 14 includes the device of any one of Examples 1-13, where, to project the vector from the pixel, the vision processor is configured to: identify an edge normal vector of the pixel; project a first vector from the pixel at 90 degrees from the edge normal vector; and project a second vector from the pixel at −90 degrees from the edge normal vector.

Example 15 includes the device of any one of Examples 1-14, where, to populate the accumulator map, the vision processor is configured to, for each vector of the projected vectors, populate, based on the vector, one or more cells the accumulator map based on at least a portion of the vector.

Example 16 includes the device of any one of Examples 1-15, where the vision processor is further configured to generate the accumulator map.

Example 17 includes the device of any one of Examples 1-16, where the accumulator map includes a set of cells associated with the portion of the image.

Example 18 includes the device of any one of Examples 1-17, where a resolution of the accumulator maps is the same or lower than a resolution of the portion of the image.

Example 19 includes the device of any one of Examples 1-18, where the vision processor is further configured to determine a candidate of the estimate of the center based on the accumulator map.

Example 20 includes the device of Example 19, where the vision processor is further configured to determine a score of the candidate based on characteristic information, a peak value of the accumulator map, or a combination thereof.

Example 21 includes the device of Example 20, where the vision processor is further configured to determine the peak value of the accumulator map.

Example 22 includes the device of Example 20 or Example 21, where the vision processor is further configured to perform a blob characterization operation on the accumulator map to generate the characteristic information.

Example 23 includes the device of any one of Examples 19-22, where the vision processor is further configured to select, based on a score of the candidate, the candidate for use as the estimate of the center of the object.

Example 24 includes the device of any one of Examples 1-23, where the vision processor is further configured to identify the object based on the estimate of the center.

Example 25 includes the device of any one of Examples 1-24, where the vision processor is further configured to track the object based on the estimate of the center.

Example 26 includes the device of any one of Examples 1-25, where the center of the object is associated with a point-of-convergence.

Example 27 includes the device of Example 26, where the point-of-convergence is associated with the multiple structures of the object.

Example 28 includes the device of any one of Examples 1-27, where the device further includes an auto pilot system configured to control an autonomous aerial refueling operation based on the estimate of the center.

Example 29 includes the device of any one of Examples 1-28, where the device further includes a thermal imaging sensor configured to generate the thermal image data.

Example 30 includes the device of any one of Examples 1-29, where the thermal image data includes long-wave infrared image data.

Example 31 includes the device of any one of Examples 1-30, where the thermal image data depicts at least a portion of the object.

Example 32 includes the device of any one of Examples 1-31, where the object is coupled to an aircraft via a hose.

Example 33 includes the device of any one of Examples 1-32, where the object includes a socket configured to be coupled to a probe of the device.

Example 34 includes the device of Example 33, where the center of the object corresponds to a center of the socket.

Example 35 includes the device of any one of Examples 1-34, where the object includes a drogue; or the device further includes a probe configured to be coupled to the object and, when coupled to the object, receive fuel via the object.

Example 36 includes the device of any one of Examples 1-35, where the device further includes a memory configured to store size information that indicates a dimension of the object, the thermal image data, or a combination thereof.

According to Example 37, a device includes a vision processor. The vision processor is configured to: obtain, based on thermal image data of an image depicting at least a portion of an object, a location associated with a point-of-convergence of multiple structures of the object; and identify the object based on the location.

Example 38 includes the device of Example 37, where the device further includes a thermal imaging sensor configured to generate the thermal image data.

Example 39 includes the device of Example 37 or Example 38, where the device further includes a probe configured to be coupled to the object and, when coupled to the object, receive fuel via the object, and where the object includes a drogue.

Example 40 includes the device of any one of Examples 37-39, where the device further includes a memory configured to store size information that indicates a dimension of the object, the thermal image data, or a combination thereof.

According to Example 41, a method includes performing one or more operations of the vision processor of the device of any one of Examples 1-40.

According to Example 42, a non-transitory, computer-readable medium stores instructions that, when executed by one or more processors, cause the one or more processors to perform operations including the method of Example 41.

According to Example 43, a vehicle includes the device of any one of Examples 1-40.

Example 44 includes the vehicle of Example 43, where the vehicle includes an aircraft.

Example 45 includes the vehicle of Example 44, where the aircraft includes an autonomous air vehicle.

Moreover, although specific examples have been illustrated and described herein, it should be appreciated that any subsequent arrangement designed to achieve the same or similar results may be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

What is claimed is:

1. A device comprising:
a vision processor configured to:
obtain, based on thermal image data representing an image that depicts at least a portion of an object, a gradient of at least a portion of the image, the portion of the image including multiple pixels associated with multiple structures of the object;
for each pixel of the multiple pixels of the portion of the image, project, based on the gradient, a vector from the pixel;
populate an accumulator map based on the projected vectors; and
determine an estimate of a center of the object based on the accumulator map.

2. The device of claim 1, wherein:
the vision processor is further configured to:
receive the thermal image data; and
calculate the gradient of the portion of the image;
the multiple structures of the object include multiple spokes that extend radially away from the center of the object; and
for each pixel of the multiple pixels of the portion of the image, the gradient includes a gradient magnitude value, a vector, a direction, or a combination thereof.

3. The device of claim 1, wherein:
for each pixel of the multiple pixels of the portion of the image, the gradient includes a gradient magnitude value and a direction or vector; and
the vision processor is configured to, for each pixel of the multiple pixels of the portion of the image, project the vector from the pixel based on the direction of the gradient at the pixel.

4. The device of claim 1, wherein:
for each pixel of the multiple pixels of the portion of the image, the gradient includes a gradient magnitude value and a direction or vector; and
the vision processor is further configured to filter the gradient to determine the multiple pixels.

5. The device of claim 4, wherein:
to filter the gradient, the vision processor is configured to, for at least one pixel, perform a comparison based on the gradient magnitude value of the pixel and a gradient threshold; and
after the gradient is filtered, each pixel of the multiple pixels has the gradient magnitude value of the pixel that is greater than or equal to the gradient threshold.

6. The device of claim 5, wherein, to filter the portion of the image to determine the multiple pixels, the vision processor is configured to discard each pixel of the portion of the image having a respective gradient magnitude value that is less than the gradient magnitude value of an adjacent pixel to the pixel.

7. The device of claim 1, wherein:
the vector is orthogonal to an edge normal vector; and
the vector has a length that is based on a size of the object.

8. The device of claim 1, wherein, for each pixel of the multiple pixels of the portion of the image, to project the vector from the pixel, the vision processor is configured to:
identify an edge normal vector of the pixel;
project a first vector from the pixel at 90 degrees from the edge normal vector; and
project a second vector from the pixel at −90 degrees from the edge normal vector.

9. The device of claim 1, wherein, to populate the accumulator map, the vision processor is configured to, for each vector of the projected vectors, populate, based on the vector, one or more cells of the accumulator map based on at least a portion of the vector.

10. The device of claim 1, wherein:
the vision processor is further configured to generate the accumulator map that includes a set of cells associated with the portion of the image; and
a resolution of the accumulator map is the same or lower than a resolution of the portion of the image.

11. The device of claim 1, the vision processor is further configured to:
determine a candidate of the estimate of the center based on the accumulator map;
determine a peak value of the accumulator map; and
determine a score of the candidate based on characteristic information, the peak value of the accumulator map, or a combination thereof.

12. The device of claim 11, wherein the vision processor is further configured to:
perform a blob characterization operation on the accumulator map to generate the characteristic information; and
select, based on a score of the candidate, the candidate for use as the estimate of the center of the object.

13. The device of claim 1, wherein:
the vision processor is further configured to:
identify the object based on the estimate of the center; and
track the object based on the estimate of the center; and
the center of the object is associated with a point-of-convergence, and the point-of-convergence is associated with the multiple structures of the object.

14. The device of claim 1, further comprising:
an auto pilot system configured to control an autonomous aerial refueling operation based on the estimate of the center;
a thermal imaging sensor configured to generate the thermal image data;
the object includes a drogue;
a probe configured to be coupled to the object and, when coupled to the object, receive fuel via the object;
a memory configured to store size information that indicates a dimension of the object, the thermal image data, or a combination thereof; or
a combination thereof.

15. A device comprising:
a vision processor configured to:
obtain, based on thermal image data of an image depicting at least a portion of an object, a location associated with a point-of-convergence of multiple structures of the object; and
identify the object based on the location.

16. The device of claim 15, further comprising a thermal imaging sensor configured to generate the thermal image data.

17. The device of claim 15, further comprising a probe configured to be coupled to the object and, when coupled to the object, receive fuel via the object, and wherein the object includes a drogue.

18. The device of claim 15, further comprising a memory configured to store size information that indicates a dimension of the object, the thermal image data, or a combination thereof.

19. A method comprising:
obtaining, based on thermal image data of an image depicting at least a portion of an object, a location associated with a point-of-convergence of multiple structures of the object; and
identifying the object based on the location.

20. The method of claim 19, further comprising:
obtaining, based on the thermal image data, a gradient of at least a portion of the image, the portion of the image including multiple pixels associated with multiple structures of the object;
for each pixel of the multiple pixels of the portion of the image, projecting, based on the gradient, a vector from the pixel;
populating an accumulator map based on the projected vectors; and
determining an estimate of a center of the object based on the accumulator map.
